(19) United States
(12) Patent Application Publication
(10) Pub. No.: US 2004/0172537 A1
(43) Pub. Date: Sep. 2, 2004

(54) System and method for tracking and authenticating items through an internet web site

(76) Inventors: George Harold Baus, Kimberly, WI (US); Peter Ralph Anderson, Appleton, WI (US); Joseph Donald Pleshek, Appleton, WI (US)

Correspondence Address: BIRCH STEWART KOLASCH & BIRCH, PO BOX 747, FALLS CHURCH, VA, 22040-0747, US

(21) Appl. No.: 10/375,078

(22) Filed: Feb. 28, 2003

(51) Int. Cl. H04L 9/00

(52) U.S. Cl. 713/170

(57) ABSTRACT

A method of securely tracking an item using an internet web site for a user to verify that the item is genuine, comprises entering a code to obtain secure access to the web site; selecting the item from a list on the web site; determining whether the code is authentic; allowing modification of tracking data if the code is determined to be authentic; and sending an alert as to a fraud potential if the code is determined to be not authentic.

### FIELD OF THE INVENTION

The present invention is directed to a system and method for tracking and assuring authenticity of items and, more particularly, tracking and assuring authenticity of items involving a computer system that is accessible for on-line interaction with users to verify that the items are in fact genuine articles.

### BACKGROUND OF THE INVENTION

In recent years, counterfeiting and misdirection of items distributed by their owners or manufacturers have become growing problems. Items, such as passports, luggage tags, stocks, bonds, negotiable instruments and consumer products, can have tags identifying the items easily removed by counterfeiters, thereby allowing the counterfeiters to redistribute the items or to resell them in the market. These items may also end up in a geographic location in which the owners or manufacturers of the items do not intend them to be.

To address the growing problem of counterfeiting, technology which can detect counterfeiting is likewise becoming more sophisticated. More permanent materials, such as taggants, have been proposed to be attached to items to make counterfeiting of items more difficult. These taggants may furthermore be read by a reader or scanned against a database to verify the authenticity of the items.

A method of reading documents to obtain and verify information recorded on the documents and to read security information to determine whether the documents are counterfeit is disclosed in U.S. Pat. No. 6,269,169, issued on Jul. 31, 2001, to Funk et al., entitled “Secure Document Reader And Method Therefor,” the contents of which are incorporated herein by reference. As described therein, magnetic and RF taggants or micro-miniature smart chips are attached to the documents, and a document reader reads alphanumeric characters or different types of bar codes imprinted on the documents. A reader verifier stores the information read from the document in a central database as a record of the bearer of the document. Multiple different attributes of the document are verified by comparison with the central database to determine the authenticity of the document.

However, in U.S. Pat. No. 6,269,169, the information read from the document is only stored in a local database which is not accessible on a more global scale to users in different locales that may need or desire to access the information for verification or other purposes. Also, no method is provided for making the information accessible on such a scale in a secure way.

U.S. Patent App. Pub. No. 2002/0023218, published on Feb. 21, 2002, to Lawandy et al., entitled “Method And Apparatus For Reading Digital Watermarks With A Hand-held Reader Device,” the contents of which are incorporated herein by reference, discloses a method of operating a hand-held device to generate digital data of a digitally watermarked image and processing the digital data to extract information encoded within the digitally watermarked image to verify the identity of an object. The extracted information is transmitted to data processor located external to the hand-held device. The data processor receives the extracted information through a data communications network, which may include or be coupled to the Internet. The digital watermark may contain a web site address which may be accessed by a user through the Internet.

However, U.S. Patent App. Pub. No. 2002/0023218 does not provide a way for dynamic access of different levels of users to the web site for verification and other purposes. No provision is made, for example, for a user to track the location of and authenticate scanned items through selected attributes on the web site or for a manufacturer or owner of items to inquire about the items in a secure way or have access to reports verifying the authenticity of the items.

### SUMMARY OF THE INVENTION

Accordingly, the present invention is directed to a system and method for tracking and authenticating substrates of items through an internet web site that substantially anticipate and prevent one or more problems due to the limitations and disadvantages of the related art.

An object of the present invention is to provide a flexible way for a user to authenticate a document or label through a query web site, where each label has unique characteristics. Information that is key to the authentication may include a variety of characteristics selected by users, for example, a thread, hologram, fluorescent tag, serial number or whatever combination of these identifying marks which can be used to verify the authenticity of items. The items may include, for example, stocks, bonds, airport luggage tags, passports or consumer products. A taggant such as a TechMark™ magnetic thread or fluorescent taggant may be used along with a second unique identifier such as the serial number or a bar code or any number of other identifiers functioning as unique identifying signatures.

Another object of the present invention is to provide a robust system in which multiple owners of product brands can verify that products are authentic, and thereby protect their brands from counterfeiting.

Yet another object of the present invention is to use a label that uses a taggant such as a TechMark™ magnetic thread or fluorescent taggant along with a second unique identifier such as a serial number or a bar code.

Yet another object of the present invention is to give one or more investigators controlled access to the web site to inquire about the products. To carry out the verification of the authenticity of products, one or more investigators may be given controlled access to the website to inquire about and validate the products. The brand owner has the ability to specify an inquiry to the investigator. This process eliminates the necessity of binders or hard copies used by investigators since the system is maintained and updated on the web site.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of securely tracking an item using an internet web site for a user to verify that the item is genuine includes entering a code to obtain secure access to the web site; determining whether the code is authentic; selecting the item from a list on the web site; allowing modification of tracking data if the code is determined to be authentic; and sending an alert as to a fraud potential if the code is determined to be not authentic.

In another aspect of the present invention, a method of defining and customizing a web site for a user to verify that an item is genuine includes adding the item onto a database linked to the web site to create an item record; adding a name or a character identifying a substrate attached to the item; and assigning a security access level to the user on the web site.

In yet another aspect of the present invention, a method of entering security data on a web site for a user to verify that an item is genuine, includes entering a code to obtain secure access to the web site; selecting the item from a list on the web site; modifying information relating to a substrate attached to the item; and saving the modified information onto a database linked to the web site. Instead of using the substrate to determine whether the item is genuine, a serial number can be engraved into the article or taggants can be embedded into the article.

In yet another aspect of the present invention, a method of securely investigating an item using an internet web site for an investigator to verify that the item is genuine includes entering a code to obtain secure access to the web site; selecting the item from a list on the web site; determining whether the code is authentic; allowing the investigator to inquire about the item if the code is determined to be authentic; and sending an alert as to a fraud potential if the code is determined to be not authentic. An alert may be received if the code reflects a geographic area outside of an authorized location of use or other restriction parameter or data set such as a minimum lot size, color, size or other parameter appropriate to the product as sold.

In yet another aspect of the present invention, a method of performing security management on an investigator using an internet web site that allows a user to view a record of the investigator includes identifying the investigator; requesting a report based on the identification on items scanned by the investigator to determine whether the items are genuine; and limiting the items scanned by the investigator to a desired period of time or geographic area.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute part of this application, illustrate embodiments of the invention and together with the description serve to explain the principle of the invention. In the drawings:

FIG. 1 illustrates a tracking and authenticating system in accordance with an embodiment of the present invention;

FIG. 2 is a flow chart illustrating the defining and customizing steps performed in the tracking and authenticating system in accordance with an embodiment of the present invention;

FIG. 3 is a flow chart illustrating the steps performed in entering security data in the tracking and authenticating system in accordance with an embodiment of the present invention;

FIG. 4 is a flow chart illustrating the tracking steps performed in the tracking and authenticating system in accordance with an embodiment of the present invention;

FIG. 5 is a flow chart illustrating the investigating and authenticating steps performed in the tracking and authenticating system in accordance with an embodiment of the present invention;

FIG. 6 is a flow chart illustrating the security management steps performed in the tracking and authenticating system in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings, wherein like reference numerals designate identical or corresponding parts throughout the several views.

The present invention makes use of the TechMark™ tracking system, which comprises a security paper substrate embedded with certain immutable characteristics. The TechMark™ tracking system is a system of tracking and assuring the authenticity of the substrate. For example, structured magnetic particles can be embedded within a paper substrate. Structured magnetic particles differ from the magnetic swipe strips typically found, for example, in credit cards in that the structured magnetic fibers are locked into position by a polymetric matrix in which they are dispersed. The structured magnetic particles can reside on a carrier thread or strip embedded in the paper or can be dispersed randomly into or on the paper. Other variations can include spot printing or spot embedding in certain predetermined areas, or embedding in predetermined quantities. The structured magnetic particles can also be applied as a coating. Other variations such as multiple populations of scratch and sniff capsules can also be advantageously employed as the taggants or markers together with a decoding electronic reader that creates an analog or digital signal indicative of the relative populations of capsules.

Typically, the magnetic fibers are subjected to a magnetic orientating field that at the time of solidifying of the polymer lock them into position. Such a substrate therefore has immutable characteristics which render the label or tag frangible, meaning that should it be removed, it will be destroyed. The orientation of the magnetic particles can no longer vary to an extent, even when later influenced by a magnet. The TechMark™ tracking system seeks to describe a method that takes advantage of this type of immutable characteristic. Furthermore, in another aspect of the present invention, the taggants may be UV taggants read by hand-held readers, such as those sold by Spectra Systems. This is one of the alternatives to using structured magnetics for the taggants. Of course, other types of markers could be used.

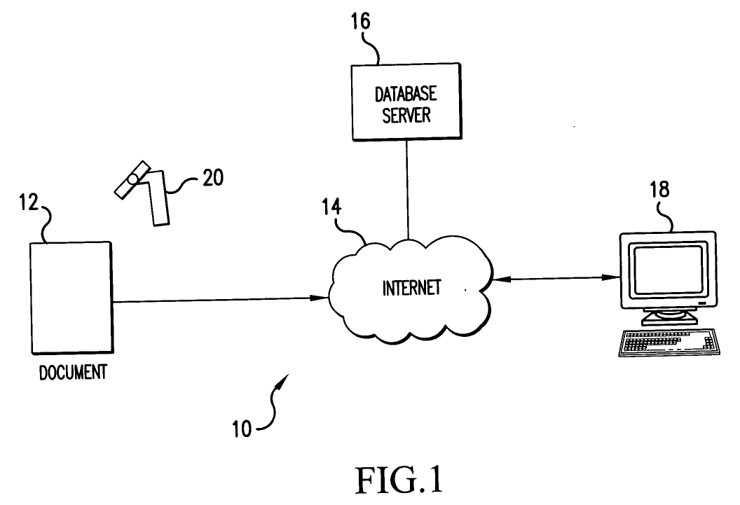

FIG. 1 illustrates a tracking and authenticating system in accordance with an embodiment of the present invention. The system 10 involves coupling the immutable characteristic in a document 12 with an addressable database of parameters that a manufacturer inputs. A database server 16 contains this database of parameters. Variable information can be inputted by downstream printers and customers which the ultimate end users desire to have tracked. The system is primarily web based. An internet web site is hosted on a computer system that reserves memory areas for each respective parameter. The database can be accessed or queried by a user at computer 18 via the Internet 14. The variable information can also be input live via an internet link, or using a batch process, where data is collected using a handheld reader and then uploaded to the database periodically.

Covert immutable parameters, for example, can be filled relating to the structured magnetic particles which may take the form of information derived from analog graphs or digitized information. Selected peaks and valleys representing a dispersion or orientation pattern of particles in a given area of the substrate can be converted into a unique number. The digital or analog derived information about the substrate's immutable parameter can form an entry in the memory area of the computer system filled by the manufacturer.

As a further part of the services, the manufacturer can make an agreement with customers as to what additional parameters should be provided in the memory area. Customers have the ability to input into the variable memory areas the parameters that the customers desire to track. For example, a printer may desire to add a serial number to the substrate or to imprint a bar code and at that point input the serial number into the web site memory area associated with a particular product. Upon further transfer of the substrate, when it becomes an important document, such as a bond, negotiable instrument, currency, passport or baggage tag label, the ultimate end user can read the various parameters using a handheld reader and query the web site database to compare against the original entries made by the manufacturer and the printer as to the authenticity of the specific document.

A large measure of flexibility is provided to individual customers to select the number of parameters to be tracked and to input information to customize each security substrate for their particular needs. Information that is input can be encrypted and decoded to add further layers of security. When the database is queried by ultimate users, the system can generate a message as to whether the queried parameters match the data that is resident in the memory.

The document 12 is read by a reader 20 capable of decoding one or both of the taggant or serial number or bar code. The Internet-linked database can be used for purposes of storing the encoded information. At the time of the document presentation, the database can be queried such as by an internet link to ascertain the authenticity of the presented document.

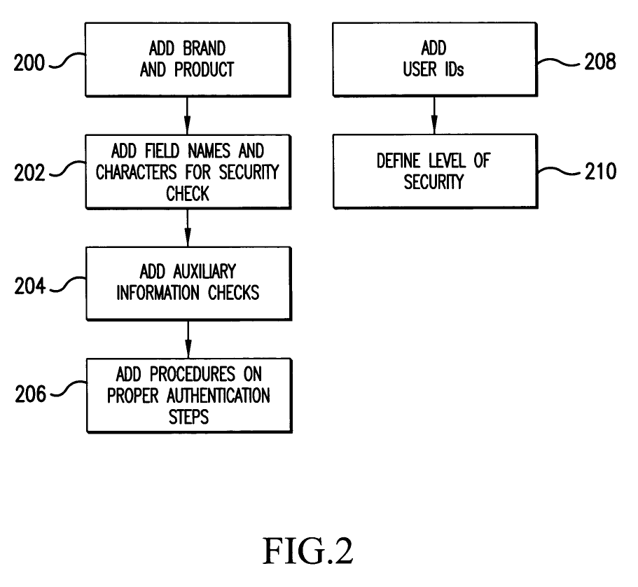

The system 10 is designed to have the ability to allow multiple “brand orders.” Customers can use some of the secure documents, threads, tag ends, and the like on the web site. The system identifies particular customers. FIG. 2 is a flow chart illustrating the defining and customizing steps performed in the tracking and authenticating system in accordance with an embodiment of the present invention. At step 200, a user, who may be a system administrator, adds a brand, product attribute or product description, definition or characteristic and a product corresponding to that information on the system. The system administrator can add field names and characters, auxiliary information checks on security parameters and steps on procedures of proper authentication, at steps 202, 204 and 206, respectively. At step 208, the system administrator adds user IDs, and at step 210 assigns the proper security level to each of the user IDs.

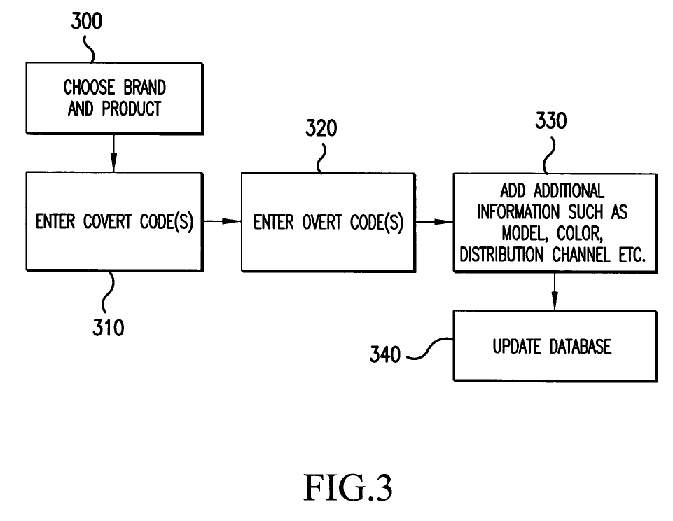

FIG. 3 is a flow chart illustrating the steps performed in entering security data in the tracking and authenticating system in accordance with an embodiment of the present invention. At step 300, a user chooses a brand and an associated product from a drop-list on the web site. At steps 310 and 320, the user enters one or more covert codes and overt codes, respectively, and then adds additional information including the model, color, distribution channel or other information to identify and distinguish the product. At step 330, the database in updated with the new information. This process may also be automated and integrated into a point of production or distribution of a product.

The database update may also be completed through an upload of a file periodically created during an executable application, the use of which may be licensed. The executable can run on a customer's network or on a single stand-alone machine. Accordingly, if a customer desires to protect the documents using this process but is uncomfortable using the web site because it may not be secure enough, the customer can opt to use the executable and run it within the customer's own infrastructure or intranet setup that would allow the customer to use the same power that most other customers would use on the web site.

A user is set up on the system as a brand owner to apply labels having security devices inside them to products that they manufacture to validate that a product is authentically owned in the marketplace. To facilitate this, a brand order record is created on the web site, and users of the system are attached to it. There are different layers of these users. System administrators are users who decide functions within the authentication process within the company, and what functions users have access to, security levels, authentication design and access levels within the process. Security user ID's allow the creation of additional users for different functions. Users can access the system on the web site via a valid user ID and password, for example. Each user is assigned an appropriate authorization level, such as inquiry only, update/inquiry or administrator. Actual workers are the people that enter data on the web site. A batch interface into this process can facilitate this process. Another level of users may be those who inquire about and look into the database or update other non-key values. These users are called investigators.

A company is set up as a brand owner on the system. A company ID maintenance screen on the web site includes fields such as those indicating the ID, name, address, city, state, zip code, country name and primary contact of the company. Labels with embedded threads are sold to the brand owner. Alternatively, the brand owner may be producing a particular product, such as coffee cups with threads embedded therein. What the brand owner wants to do is to make sure that when a customer goes to a store and buys the brand owner's brand of cups, the labels on the cups indicate that the cups are authentic. If an investigator obtains one of these cups and swipes the thread against the database using the web site, the investigator can determine whether the cups are authentically produced by the brand owner.

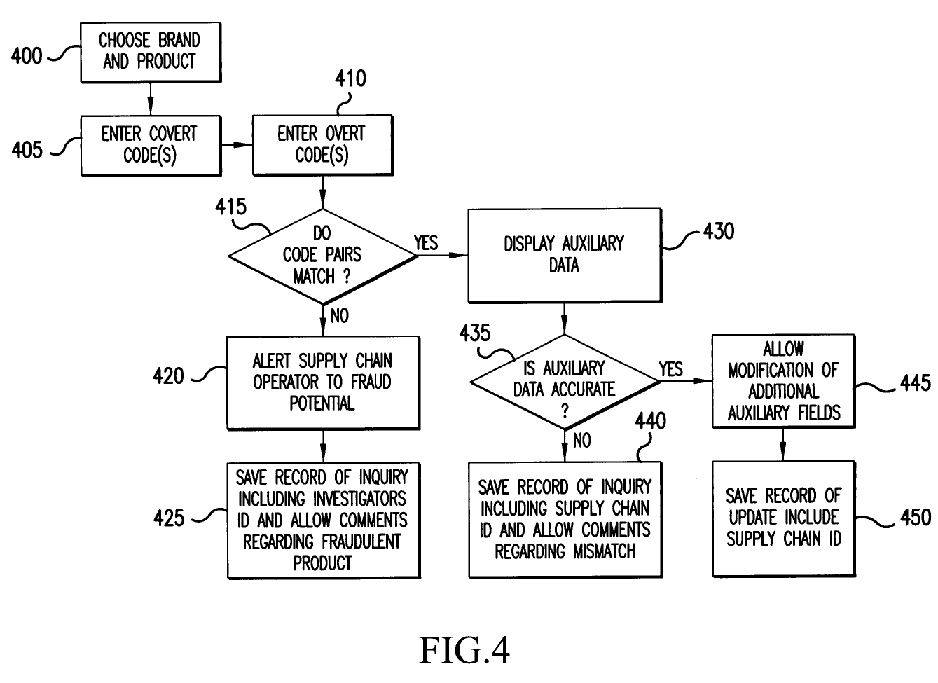

Once the brand owner is set up on the system, the brand owner can define all the brands that the brand owner desires to track for authenticity or all the products that the brand owner desires to complete the brand protection function. FIG. 4 is a flow chart illustrating the tracking steps performed by the brand owner or other system user in the tracking and authenticating system in accordance with an embodiment of the present invention. In step 400, the brand owner chooses a brand and/or a product from drop-down lists on the web site. In steps 405 and 410, the brand owner enters one or more covert and overt codes, respectively. In step 415, the system determines whether the code pairs match, and if they match, then in step 430, auxiliary data is displayed on the web site for the brand owner. If the auxiliary data is accurate in step 435, then in step 445, the system allows modification of additional auxiliary fields, and in step 450, the record of the update including a supply chain ID is saved on the system. If the auxiliary data is not accurate in step 435, then a record of the inquiry including a supply chain ID is saved on the system and comments regarding the mismatch are added in step 440. If the code pairs do not match in step 415, then in step 420, the supply chain operator is alerted to a fraud potential, and a record of the inquiry including an investigator's ID is saved on the system and comments are added regarding the potential fraudulent product in step 425.

Once the brand owner gets to a level where the brand owner has a specific style of coffee cup, the brand owner can then use a special screen that the brand owner designs. The brand owner can decide what kind of information is key to the authentication. This information may include the embedded thread in the label. It may be the embedded thread and a barcode that can be scanned. It may be a fluorescent tag, a hologram, or a serial number that is typed on it. The process allows flexibility for the brand owner to define what makes a unique key or what fully qualifies the authenticity of the particular product.

As the brand owner ships out products, the brand owner applies the appropriate labels to the products, and enters this information into the system on the web site. This data entry process can be automated and integrated with the manufacturing system. However, in a massive batch mode, the batch interface is designed to allow the brand owner to enter each individual item on the web site. The brand owner may choose to sell one product with the same label on every occurrence of that product. The brand owner may choose to enter that information onto the web site, and assign an investigator to obtain the particular product. To do this, the brand owner issues a user ID to the investigator and gives the investigator specific rights within the system. These rights may include rights to a particular brand within the company.

One of the ways that the brand owner can track down problems are via the labels themselves. The embedded threads, the barcodes, and the holograms can be used by the brand owner as keys into the system to validate that there is an entry for that product. However, other kinds of information is not necessarily scanned with an electronic device. It could be something like an authorized distribution point. If, for example, the brand owner's cups are only to be sold in a particular geographic region, the brand owner can indicate that in the labels. Doing this lets the brand owner track the location of the product, and know if a product is scanned outside the specified geographic location.

Not only can the electronic images or the authentication procedures be stored, but there can be a link back to the brand owner's web site or another designated server to store the information. This allows the brand owner to maintain an even higher control over the content and the flexibility in the system since the brand owner does not have to rely on the administrators to perform updates for the brand owner on the web site. The brand owner can update the procedures themselves.

On the web site, the brand owner defines the brands and the products corresponding to each brand on an authentication entry screen. The brands and products are assigned to the brand owner's user ID. The brand owner selects these brands and products from a drop-down list. Next, a screen appears inquiring the brand owner as to what kinds of data the brand owner desires to collect and how the brand owner desires to verify that information. The brand owner is requested to provide up to a certain number of variable names as well as some field lengths, and indicate which one of these is a key field to a particular label. The number of variable names and the field lengths are optionally selected and are not intended to be limiting. The field name may be a thread, a thread and barcode or a serial number. The brand owner defines this himself by check boxes on the actual page. This way, the brand owner stores the authentication attributes for that particular product.

To authenticate a brand or product, a user accesses a procedure menu screen, selects a product from a drop-down list and clicks on “show procedures” to view the authentication procedures. To maintain brands and products on the system, the brand owner accesses a brand maintenance screen or a product maintenance screen, selects a brand or a product, and adds or modifies its attributes. When the user enters data for that product or to authenticate for that product, the screens will dynamically come up with the names provided by the brand owner, with the key fields being required. The user cannot get past the initial screens without entering the key fields. Whatever data is meant to just be displayed back to the user is really in a non-enterable field. It just displays the information back on the screen.

Thus, the brand owner enables up to a desired number of data entry fields on that page, and identifies to the system what fields will be key fields, which ones are required. They do not have to be key fields to be required. For instance, the brand owner may say that for a particular product, the thread is the only key field into the system, but the brand owner is required to put the destination or the manufacturing origin. Once the brand owner stores that information, all entry screens and inquiry screens for that same product will come up with that same look.

An additional feature is the ability for the brand owner to specify what things to look for during the investigation. Conventionally, investigators carry a lot of binders in the trunk of their car, for example. Manual updating has to be done for the binders. All such instruction can be maintained on the web site and updated much more easily and timely to eliminate any type of confusion.

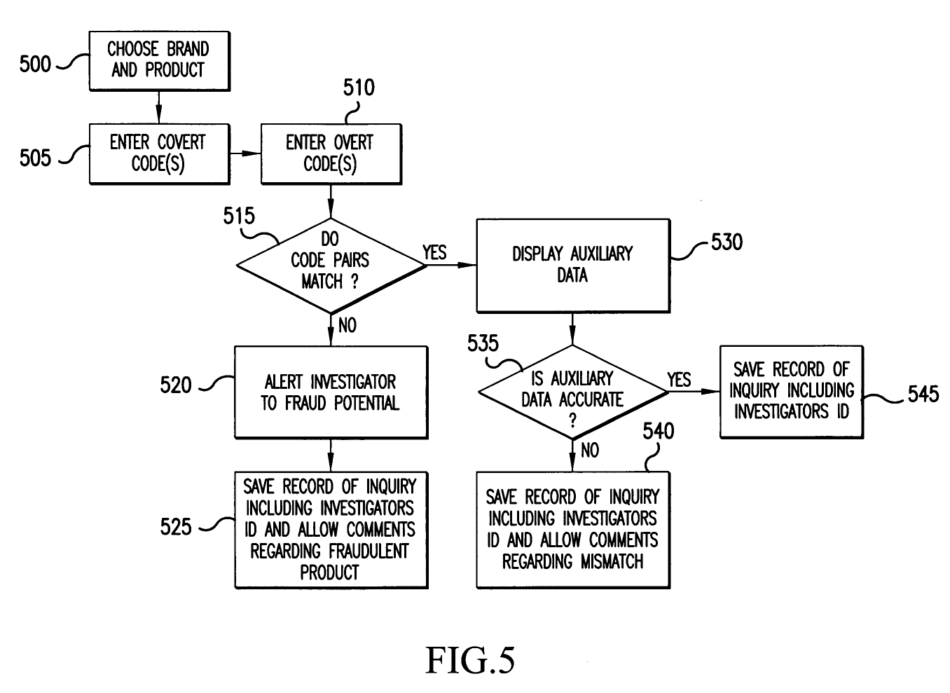

FIG. 5 is a flow chart illustrating the investigating and authenticating steps performed by the investigator in the tracking and authenticating system in accordance with an embodiment of the present invention. The description of steps 500 to 515, 530 and 535 in FIG. 5 is omitted since those step are similar to steps 400 to 415, 430 and 435, respectively, in FIG. 4. A record of the inquiry including the investigator's ID is saved in the system at step 545 if the auxiliary data is accurate. If the auxiliary data is not accurate, then a record of the inquiry including the investigator's ID is saved in the system in step 540 and comments regarding the mismatch are added. If the code pairs do not match, the investigator is alerted to the fraud potential in step 520, and a record of the inquiry including the investigator's ID is saved in step 525 and comments regarding the fraudulent product are added.

In this way, the web site is used to determine whether the products investigated are valid. The investigator verifies that the labels are, in fact, part of that product, because they form a unique combination in the system. The investigator responds on the system by informing the brand owner either that the brand owner has valid products in the market or that there are problems. If an investigator finds a major potential problem while determining the authenticity of a particular product, the investigator may contact the brand owner immediately to identify the nature of the problem.

The successful verifications and failures and subsequent reporting done by the investigator is stored in a database of the system. There are reporting capabilities built into the system that allow the brand owner to be informed of what is going on with a particular brand including all the products within the brand, or a particular product or even an investigator. A reports menu on the web site allows a brand owner or other authorized user to view the system reports by viewing an authentication pass/fail report. The brand owner can specify how the report is to be built. The brand owner can limit the report to a particular brand, product, user ID or a period of time between specified dates. A “sort” column allows the brand owner to indicate an ascending or descending sequence for each selection. A “use” column allows the brand owner to limit the report by values entered for each group. If, for example, the brand owner is concerned whether a particular investigator is performing his job properly, the brand owner can view in the report the number of items the investigator has scanned in a particular period of time. The brand owner has on demand access to these reports.

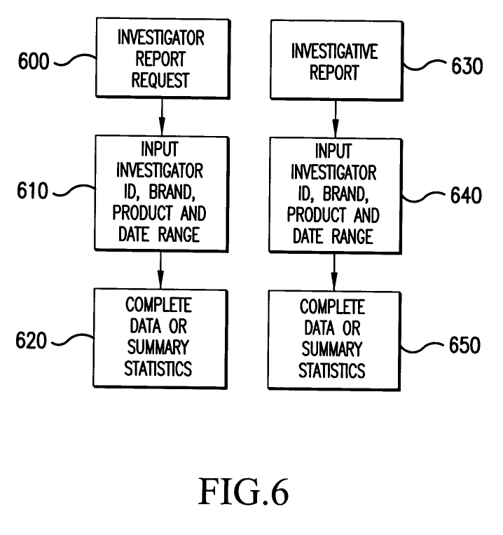

FIG. 6 is a flow chart illustrating the security management steps performed by the brand owner in the tracking and authenticating system in accordance with an embodiment of the present invention. At step 600, the brand owner makes an investigator report request on the web site if the brand owner wants to track how the investigator is doing his job. At step, 610, the brand owner inputs the investigator ID, the brand, product and date range. At step 620, the system completes the data or summary statistics. At step 630, the brand owner makes an investigative report on the web site if the brand owner desires to track an investigation of a brand or product. The description of steps 640 and 650 is omitted since those steps are similar to steps 610 and 620, respectively.

An additional application is the protection of documents. For example, a bond may be stored, even with an interest rate and a maturity date onto the database to verify not only that the document is authentic, but that the information on the document itself matches up with what the document is supposed to indicate. The document is held in a secure database. This can also be applied to passports, luggage tags, stocks, car titles, home titles, etc.

An example of two markets to which the present invention is immediately relevant is after-market spare parts and pharmaceuticals. In the airline industry, for example, an estimated ten percent of spare parts are currently fraudulent. The sole protection for these spare parts are currently tags affixed to the parts. These tags are easy to counterfeit. If these tags are replaced with labels or tags having unique and encrypted threaded parts, then it would be difficult to find a match for the threaded parts. Authentication of the part can be accomplished. Moreover, the use of frangible tags which easily tear can prevent tampering with the tags. The appropriate tag will be kept with the associated spare part.

In pharmaceutical applications, drug manufacturers sell drugs overseas to third world and other countries and the drugs might come back into the U.S. at a reduced price. They are often exposed to environmental factors such as heat or moisture, and can be rendered unusable. Most likely, records in the database can involve the geographical destination for the pharmaceuticals. Using the system of the present invention, distributors and users can track and trace the origin and destination of the drugs. This information can be contained in the label, which would make the drugs difficult to counterfeit.

Numerous additional modifications and variations of the present invention are possible in light of the above teachings. It is therefore to be understood that within the scope of the appended claims, the invention may be practiced otherwise than as specifically described herein.

What is claimed is:

1. A method of securely tracking an item using an internet web site for a user to verify that the item is genuine, comprising:
entering a code to obtain secure access to the web site;
selecting the item from a list on the web site;
determining whether the code is authentic;
allowing modification of tracking data if the code is determined to be authentic; and
sending an alert as to a fraud potential if the code is determined to be not authentic.

2. The method of securely tracking an item according to claim 1, wherein the code is at least one of an overt code and a covert code.

3. The method of securely tracking an item according to claim 1, wherein modified tracking data is saved into a database.

4. The method of securely tracking an item according to claim 1, wherein a record of an ID of the user is saved in a database if the code is determined to be not authentic.

5. A method of defining and customizing a web site for a user to verify that an item is genuine, comprising:
adding the item onto a database linked to the web site to create an item record;
adding a name or a character identifying a substrate attached to the item; and
assigning a security access level to the user on the web site.

6. The method of defining and customizing a web site according to claim 5, wherein the security access level is one of owner, inquirer and system administrator.

7. The method of defining and customizing a web site according to claim 5, wherein the name includes at least one of a thread, a bar code and a serial number.

8. The method of defining and customizing a web site according to claim 5, wherein the name or character can be indicated as being a key field or a required field in identifying the substrate.

9. A method of entering security data on a web site for a user to verify that a an item is genuine, comprising:
entering a code to obtain secure access to the web site;
selecting the item from a list on the web site;
modifying information relating to a substrate attached to the item; and
saving the modified information onto a database linked to the web site.

10. The method of entering security data on a web site according to claim 9, wherein the code is at least one of an overt code and a covert code.

11. The method of entering security data on a web site according to claim 9, wherein the information is automatically modified using an executable application.

12. A method of securely investigating an item using an internet web site for an investigator to verify that the item is genuine, comprising:
entering a code to obtain secure access to the web site;
selecting the item from a list on the web site;
determining whether the code is authentic;
allowing the investigator to inquire about the item if the code is determined to be authentic; and
sending an alert as to a fraud potential if the code is determined to be not authentic.

13. The method of securely investigating an item according to claim 12, wherein the code is at least one of an overt code and a covert code.

14. The method of securely investigating an item according to claim 12, wherein the inquiry is saved into a database.

15. The method of securely investigating an item according to claim 12, wherein a record of an ID of the investigator is saved in a database if the code is determined to be not authentic.

16. The method of securely investigating an item according to claim 12, wherein the investigator determines that the item is valid if the inquiry indicates that a substrate attached to the item has a unique label.

17. A method of performing security management on an investigator using an internet web site that allows a user to view a record of the investigator, comprising:
identifying the investigator;
requesting a report based on the identification on items scanned by the investigator to determine whether the items are genuine; and
limiting the items scanned by the investigator to a desired period of time.

18. The method of performing security management on an investigator according to claim 17, further comprising:
saving the identification of the investigator if it is determined that no items are scanned during the period of time.
